(19) United States
(12) Patent Application Publication
(10) Pub. No.: US 2026/0219735 A1
(43) Pub. Date: Jul. 30, 2026

(54) Unified System for Gesture Recognition, Text Generation, and Multi-Modal Communication

(71) Applicant: Perennity Inc., Campbell, CA (US)

(72) Inventor: Oladayo Ayokunle Luke, Campbell, CA (US)

(73) Assignee: Perennity Inc., Campbell, CA (US)

(21) Appl. No.: 19/040,873

(22) Filed: Jan. 30, 2025

(51) Int. Cl. G06F 3/01; G06F 40/58; G06T 13/00; G06V 10/72; G06V 10/774; G06V 10/776; G06V 40/20; H04L 9/40

(52) U.S. Cl. CPC G06F 3/017; G06T 13/00; G06V 10/72; G06V 10/774; G06V 10/776; G06V 40/28; H04L 63/04; H04L 63/1425; G06F 40/58

(57) ABSTRACT

advancements in human-computer interaction, supporting touchless interfaces, adaptive assistive technologies, and intelligent automation across diverse environments. The present invention introduces an integrated platform (also known as Inclusive GPT) for gesture recognition, text generation, and multi-modal communication, leveraging advanced hardware, edge computing, and AI-driven models for real-time interaction. At its core, the Three-Stage Gesture Generative Multi-Modal Transformer (TGGMT) combines multi-modal gesture recognition and generative capabilities, employing bidirectional loss computation to enhance fluency and accuracy in gesture sequences. A validation loss-driven augmentation strategy (Data Augmentation Method (DAM) 0-N) dynamically adjusts augmentation levels based on experiment configurations, ensuring progressive model refinement without premature convergence. The system integrates federated learning to enable privacy-preserving, on-device gesture model adaptation, reducing cloud dependency while maintaining real-time responsiveness. Applications span accessibility tools, human-computer interaction, industrial automation, and virtual reality, where gesture-to-text translation, gesture-conditioned commands, and real-time video generation enhance usability. By integrating adaptive learning, scalable architecture, and privacy-conscious design, Inclusive GPT sets a new standard for gesture-driven AI applications across diverse domains.

### CROSS-REFERENCE TO RELATED APPLICATION

This application claims priority from and the benefit of U.S. Provisional Patent Application No. 63/664,187 , filed Jun. 26, 2024, entitled “Unified System for Gesture Recognition, Text Generation, and Audio Output,” which is hereby incorporated by reference in its entirety, as if set forth in full in this document, for all purposes.

### TECHNICAL FIELD

Certain embodiments of the present invention relate to the fields of artificial intelligence, gesture recognition systems and methods, particularly to multi-modal gesture recognition platforms that leverage advanced sensor technologies, computer vision, artificial intelligence (AI), deep learning, and machine learning (ML) for real-time interaction and communication. Specifically, these embodiments address systems and methods for sign language recognition and gesture detection using neural networks, including Convolutional Neural Networks (CNNs), Recurrent Neural Networks (RNNs), Transformers, and Long Short-Term Memory (LSTM) networks. The invention also incorporates Large Language Models (LLMs) and data augmentation techniques, all together referred to as Inclusive GPT, to enhance recognition accuracy, adaptability, and robustness. The invention focuses on applications that promote touchless interaction, enhance accessibility for the deaf and hard-of-hearing community through sign language recognition, and improve hygiene and productivity in various environments. The invention introduces a validation loss-driven augmentation strategy (DAM 0-N) that dynamically adjusts data augmentation intensity based on experiment-specific configurations, ensuring continuous model refinement without premature convergence. It integrates federated learning, allowing on-device model adaptation while maintaining data privacy and reducing cloud dependency. Additionally, it includes systems for edge and cloud-based processing, privacy-preserving mechanisms such as edge processing, secure encryption, and anomaly detection models, and multi-agent collaboration to support secure, scalable, and adaptive gesture-based solutions across various sectors including healthcare, education, corporate environments, public services, and industrial automation.

### BACKGROUND

The need for effective sign language recognition systems is evident in the daily communication challenges faced by millions of individuals with hearing impairments. Traditional methods, such as written notes or lip reading, are often cumbersome, inefficient, and unreliable. While professional sign language interpreters are highly effective, they are not always available or affordable, highlighting the need for a technology-driven solution that provides real-time, accurate, and accessible communication support. Additionally, gesture recognition systems have become a cornerstone of modern human-computer interaction, enabling intuitive, touchless control and accessibility across domains such as healthcare, education, entertainment, and industrial automation. These systems also promote silent communication, proficiency in sign languages, and the adoption of gestures as a natural means of interaction. By leveraging technologies such as sensor arrays, artificial intelligence (AI), and edge-cloud integration, gesture recognition systems can interpret gestures to execute commands, enhance communication, promote hygiene, and boost productivity by reducing physical touch in shared environments. The increasing prevalence of AI and machine learning presents an opportunity to bridge communication gaps for the deaf and hard-of-hearing community. However, despite this potential, existing solutions fall short in critical areas, including real-time processing, adaptability to diverse environments, multi-modal integration, and addressing privacy concerns, limiting their adoption and efficiency. Recent advancements-such as multi-modal data fusion, edge-based processing, federated learning, privacy-preserving algorithms, and the integration of Inclusive GPT, aim to address these challenges, paving the way for scalable, adaptive, and secure gesture recognition platforms suitable for diverse applications.

The increasing demand for touchless interaction and accessible communication technologies in diverse environments remains unfulfilled due to the limitations of existing systems. Current gesture recognition solutions rely on camera-based systems or cloud-dependent processing, which face significant challenges. Camera-based systems are intrusive, raising privacy issues in sensitive environments such as healthcare or private spaces. Solutions that depend on cloud infrastructure often suffer from high latency, reduced reliability in offline scenarios, and increased data security risks. Furthermore, traditional systems struggle with gesture recognition under complex conditions, including low lighting, occlusion, or the detection of subtle motions such as finger gestures or micro-expressions.

Another major limitation of existing systems is their inability to integrate multiple data streams, such as visual, inertial, and contextual information, into a cohesive and robust recognition model. Many solutions are device-specific and lack platform-agnostic designs, restricting their adaptability across diverse hardware platforms and edge devices. These constraints prevent current technologies from meeting the needs of users in applications ranging from assistive technology to virtual reality and industrial automation.

The Gesture Cognition Engine (GCE) addresses these gaps by combining advanced multi-modal processing, real-time anomaly detection, and adaptive gesture-to-command mapping into a unified framework, enabling robust, low-latency, and privacy-conscious gesture recognition across edge and cloud environments. Complementing this, the Edge Computing Device, and its Controller (ECDC), in conjunction with Gesture Genius and PoseTrack, provides real-time processing on the edge, ensuring low-latency and offline capabilities. By leveraging IMU-based sensors for gesture recognition, the platform remains effective even in environments where cameras are impractical or unavailable.

The system incorporates the Three-Stage Gesture Generative Multimodal Transformer (TGGMT), which combines multi-modal inputs such as IMU sensor data, visual data, and contextual cues to achieve unparalleled accuracy. The platform further supports secure, private, and flexible deployment options, making it suitable for a wide range of applications in personal, corporate, and industrial domains. Its modular architecture ensures seamless integration and adaptability across a variety of hardware platforms.

This invention fulfills the unmet need for a robust, versatile, and privacy-conscious gesture recognition platform capable of transforming touchless interaction across domains. By addressing the limitations of existing solutions, the system sets a new standard for accessibility, efficiency, and adaptability in gesture-driven technologies.

The lack of effective sign language recognition and gesture-based communication systems creates significant barriers for millions of individuals with hearing impairments, limiting their ability to communicate efficiently and participate fully in society. Traditional methods, such as written communication or lip reading, are not only time-consuming and imprecise but also fail to capture the richness and context of real-time interactions. The unavailability and excessive cost of professional sign language interpreters exacerbate the problem, leaving many individuals without accessible communication solutions in critical environments such as healthcare, education, and workplaces.

Furthermore, as gesture-based interaction becomes a cornerstone of modern human-computer interaction, current systems fail to provide scalable, dependable, and privacy-conscious solutions for broader applications. Existing systems often struggle with real-time gesture processing, adaptability to diverse environments, and the integration of multi-modal inputs such as visual, inertial, and contextual data. This limits their effectiveness in applications ranging from assistive technologies to industrial automation. Additionally, these shortcomings hinder the promotion of silent communication, proficiency in sign languages, and natural gesturing as efficient interaction methods, leaving a gap in accessible, intuitive communication tools. Privacy concerns, latency issues, and poor adaptability in dynamic or resource-constrained settings further prevent existing solutions from being widely adopted. The consequences of these limitations are far-reaching, resulting in reduced accessibility, productivity, and inclusivity for individuals and systems relying on gesture recognition technology. This presents a pressing need for scalable, adaptive, and secure solutions that bridge the gap between existing technologies and the demand for real-time, accessible, and reliable gesture-based communication systems.

### PRIOR ART

Unsupervised Movement Detection and Gesture Recognition (U.S. Pat. No. 9,697,418B2): This patent describes a system and method for detecting and recognizing human movements and gestures without prior supervision. It utilizes sensors to capture motion data, which is then processed to identify specific gestures. The system can learn and adapt to new gestures over time, enhancing its recognition capabilities.

This patent describes an unsupervised movement detection and gesture recognition system using depth sensing and pattern analysis. However, it relies heavily on camera-based systems and depth sensors, which pose privacy concerns and are impractical in environments with poor lighting or occlusion challenges. The system also lacks integration with multi-modal inputs (e.g., IMU sensors), reducing accuracy in complex scenarios. Furthermore, the absence of real-time edge processing results in latency issues for applications requiring immediate responsiveness.

To address these challenges, integrating multi-modal inputs such as IMUs with contextual data can improve gesture recognition in diverse environments. Implementing edge processing technologies and lightweight AI models could ensure real-time performance while minimizing latency. Privacy-preserving approaches, such as anonymized data processing or on-device recognition, could expand its applicability.

Systems and Methods of Determining Interaction Intent in Three-Dimensional (3D) Sensory Space (US20240370091A1): This patent outlines systems and methods for interpreting user intent within a 3D sensory environment. It employs sensors to monitor user movements and interactions in a three-dimensional space, enabling the system to discern the user's intended actions or commands. This technology is applicable in virtual reality, augmented reality, and other immersive environments.

This patent focuses on determining interaction intent in 3D sensory spaces through sensory data like hand or body movements. However, it relies on expensive 3D sensory equipment, making it inaccessible for many applications in resource-constrained environments. The system lacks edge-based processing capabilities, relying on centralized systems that introduce latency and reduce reliability in scenarios with content. The primary advantage of TGO lies in its ability to enhance inclusivity, ensuring digital content is accessible to users with hearing impairments by bridging communication gaps through gesture-based overlays.

The Video-to-Gesture Overlay (VGO) subsystem converts video inputs into gesture overlays, creating rich, multi-modal outputs suitable for entertainment, education, and virtual reality environments. By providing visual enrichment for video content, VGO makes it more engaging and adaptable for diverse audiences. Its key advantage is its utility in immersive AR/VR applications, where dynamic gesture overlays enhance interactivity and user experience. Similarly, the Real-Time Text-to-Gesture Streaming (RTGS) subsystem supports instant communication by streaming gestures in real time from text inputs or contextual data. Its latency-sensitive design makes it ideal for applications like live-streamed accessibility services, video conferencing, and interactive events, ensuring accurate and immediate communication in dynamic settings.

The Gesture Recognition to Text (GRT) subsystem translates gestures into text outputs with high accuracy by utilizing multi-modal inputs such as IMU sensors, visual data, and contextual information. This empowers individuals to communicate effectively, particularly in environments where typing or speaking is impractical. The Multi-Agent Collaboration (MAC) subsystem further enhances productivity by synchronizing gestures, commands, and outputs across multiple devices and users. This functionality is particularly advantageous in collaborative environments like workplaces, classrooms, and remote meetings, where seamless multi-user interactions foster better teamwork and coordination.

The Gesture Video Generation (GVG) subsystem automates the creation of gesture-based videos for education, marketing, and virtual environments. It streamlines the production of engaging visual content, significantly reducing manual effort and enabling creators to generate gesture-rich experiences efficiently. Finally, the Gesture Cognition Engine (GCE) serves as the core for input validation, anomaly detection, and multi-modal gesture recognition. It integrates advanced capabilities such as Gesture Recognition to Text (GRT) and Real-Time Gesture Streaming (RTGS), ensuring robust reliability, optimized performance, and scalable operations. By combining edge-based low-latency processing with cloud-based complex computations, the GCE delivers accurate, responsive interaction and enhances overall system performance and user experience.

The User Interfaces (UI) of the platform integrate seamlessly with both web-based and standalone interfaces, enabling intuitive gesture customization and execution. These interfaces provide real-time feedback and visual tools, empowering users to configure and manage gestures with ease. This enhances usability and engagement by offering a user-friendly environment for gesture-based interactions. The ability to adapt gestures to specific applications and receive instant feedback makes the UI an essential component for accessible and efficient operation.

The platform also supports Desktop Applications, offering robust integration at the operating system level. This includes gesture-to-keyboard or mouse mapping and text-to-gesture overlays, enabling professionals to control desktop environments hands-free. By improving accessibility and efficiency, this capability is particularly valuable in productivity-focused tasks where hands-free operation can streamline workflows. Similarly, Mobile Applications extend the system's functionality to portable devices, providing cross-platform compatibility for gesture recognition and command execution. This allows gestures to trigger actions on phones, apps, or IoT devices, introducing touchless interaction to mobile ecosystems. With this capability, the platform caters to on-the-go users and expands accessibility in mobile environments.

Finally, the Gesture Genius Device acts as a portable edge computing solution for capturing, processing, and executing gestures in real time. Equipped with built-in sensors and TGGMT-based models, it delivers low-latency gesture recognition and ensures privacy by eliminating the need for constant cloud connectivity. This makes it ideal for secure or offline applications, where reliability and data privacy are critical. The device's portability and advanced processing capabilities provide a comprehensive solution for gesture recognition across a variety of use cases.

The Multi-Modal Input Integration capability combines data from cameras, IMU sensors, and contextual sources to achieve highly accurate and robust gesture recognition. This integration ensures that the platform remains functional in diverse environments, including those where cameras are impractical or restricted, such as privacy-sensitive settings. The versatility of this system makes it ideal for a broad range of applications, from assistive technologies to enterprise automation. Complementing this is Edge Computing with ECDC (Edge Computing Device Controller), which acts as a bridge between the user interface and the Rotational Stand. The ECDC ensures accurate and efficient command execution by facilitating seamless communication and real-time processing. This reduces latency, enhances reliability, and supports intuitive interactions across desktop and web platforms, enabling consistent performance in both online and offline scenarios.

The platform also demonstrates exceptional Scalability and Flexibility, seamlessly integrating with various clients, including UI interfaces, desktop, PoseTrack and mobile applications, and the Gesture Genius device. This adaptability allows it to cater to a wide range of use cases, from individual accessibility to enterprise-level automation. Additionally, the platform offers Customizable and Adaptive Features, enabling users to dynamically map gestures to commands, configure settings, and personalize gesture-to-output mappings through intuitive interfaces. With Enhanced Privacy and Security, the system addresses privacy concerns by incorporating non-camera-based gesture recognition through PoseTrack, which eliminates the need for visual data in sensitive environments, expanding its application potential while ensuring secure operation.

At the core of the system is the Three-Stage Gesture Generative Multi-Modal Transformer (TGGMT), a cutting-edge deep learning model designed to interpret and generate gestures with unparalleled accuracy. The TGGMT employs a Three-Stage Training Workflow to enhance its capabilities. In Stage 1, the Multi-Modal Transformer establishes a robust baseline for gesture recognition, using token-level and word-level configurations while employing a bidirectional loss strategy to capture temporal dependencies in both forward and reversed sequences, improving gesture fluency and recognition accuracy. Stage 2 introduces Dataset Scoring and CutMix Augmentation, optimizing dataset diversity and robustness by combining sequences and labels, supporting auxiliary learning, and enabling the model to handle complex gestures with higher generalization capacity. In Stage 3, a Generative Pre-trained Transformer is integrated with Conditional Gradient Updates, enabling gesture-conditioned natural language generation at word and character levels. A callback-based augmentation strategy dynamically adjusts Data Augmentation Module (DAM) levels (0-N) based on validation loss stability, ensuring progressive model refinement without premature early stopping. Advanced adaptive transformations, including Time Warping, Scale/Translation, Brightness Normalization, Mirror Gesture, and Noise Reduction, enhance robustness against real-world imperfections, such as varying gesture speeds, sensor noise, and spatial distortions. The conditional gradient updates dynamically refine model parameters based on edit accuracy thresholds, ensuring real-time adaptation and precision in diverse application scenarios.

### DETAILED DESCRIPTION

Embodiments are directed toward a robust and scalable platform for gesture recognition, text generation, and multi-modal communication, enhancing user interaction, accessibility, and control across diverse environments and applications. By integrating advanced hardware components, such as rotational stands, IMU-based sensors, and edge computing devices, with sophisticated software frameworks, the invention enables real-time processing and execution of gestures as commands, actions, or communication outputs. This system leverages multi-modal data streams, including visual inputs, inertial sensor data, and contextual information, to achieve highly accurate recognition of static, dynamic, and complex gestures, such as sign language or intricate body movements. Unlike existing solutions, which often rely on cloud-dependent infrastructure or intrusive camera-based systems, this invention emphasizes privacy-conscious, low-latency, and resource-efficient processing through edge-based hardware and federated learning techniques.

The embodiments hardware integration focuses on seamlessly connecting multiple devices and sensors to achieve accurate gesture recognition, processing, and execution in real time. The hardware architecture includes Gesture Genius, Rotational Stand, PoseTrack, and edge computing devices equipped with advanced processing capabilities, ensuring low-latency operations and adaptability to diverse environments.

The Edge Computing Device Controller (ECDC) serves as the central bridge between the user interface (UI) and the Rotational Stand, ensuring accurate and efficient execution of commands. It facilitates communication and coordination between connected hardware components, including IMU sensors, Bluetooth connectivity modules, and optional camera systems. Custom controllers manage the interaction between the hardware and software layers, translating UI commands into actionable instructions for the Rotational Stand while processing real-time feedback from hardware components. This ensures seamless gesture execution, reduces latency, and supports interoperability across various subsystems, enabling consistent performance across desktop and browser environments.

Gesture Genius is a lightweight, mobile device equipped with proximity sensors for transferring gestures and IMU sensors for tracking position and motion. It can capture gesture landmarks and transfer them to other devices, such as the Rotational Stand, for further processing. It communicates with the ECDC over Bluetooth or USB, ensuring efficient two-way data exchange. Its mobility allows it to interact with other devices, providing flexibility in gesture collection and processing. This makes it ideal for portable or on-the-go applications.

The Rotational Stand is capable of independently capturing gestures using embedded sensors, including tracking multiple skeleton gestures. It is configurable to adapt to specific gesture recognition tasks, processes gestures locally, perform inference, updates dashboards, and tracks movement for monitoring purposes. It offers robust local processing and tracking capabilities, reducing reliance on external devices. Its ability to capture multiple skeleton gestures and update dashboards in real time makes it suitable for fixed environments requiring comprehensive gesture analysis and monitoring.

PoseTrack is designed to address the limitations of conventional motion tracking systems by introducing a first and second electronic device architecture. Each device is equipped with an integrated UART device that ensures efficient, low-complexity communication between IMU sensors and processing units. The first electronic device handles IMU data from the left side of the body, while the second electronic device manages data from the right side. This distributed approach enables precise tracking of left and right landmarks and their positions. The Conventional UART systems face challenges in supporting multiple master or slave devices, leading to scalability limitations and increased hardware complexity. PoseTrack overcomes these challenges by incorporating UART devices with multi-channel capabilities, allowing simultaneous communication with multiple sensors and reducing complexity and costs.

PoseTrack leverages a dual-device architecture, with each device handling motion tracking for one side of the body. The first electronic device processes data from left-side IMU sensors, including fingers, wrists, elbows, shoulders, hips, knees, and ankles. It features a dedicated UART device for communication with the central processing unit or Rotational Stand. The second electronic device manages data from right-side IMU sensors corresponding to the same body parts. This device operates independently but synchronizes with the first device, ensuring seamless and accurate full-body motion tracking. Each electronic device integrates a UART module designed for efficient communication. The UART module includes two micro-controllers coupled to enable parallel processing, providing multiple UART channels for simultaneous communication with IMU sensors. Additionally, a plurality of UART ports allows the devices to connect seamlessly with sensors and peripherals, facilitating high-performance data exchange.

PoseTrack's architecture allows each electronic device to communicate independently with multiple IMU modules. This capability ensures real-time data transmission and reduces latency, providing precise and timely motion tracking even in complex scenarios. PoseTrack minimizes hardware complexity by employing multi-channel UART devices to manage multiple IMUs for each side of the body. This streamlined design ensures cost-effective scalability for tracking additional landmarks without adding significant processing or hardware costs.

PoseTrack uses IMU sensors to capture detailed motion data from both the upper and lower body. For upper body motion tracking, sensors on fingers, wrists, elbows, and shoulders monitor arm movements, gestures, and poses. For lower body motion tracking, sensors on hips, knees, and ankles track motions such as walking, stepping, and crouching. Each electronic device transmits its data through UART channels to the Rotational Stand or cloud-based servers. These data streams are processed by advanced machine learning models, s such as the Three-Stage Gesture Generative Multimodal Transformer (TGGMT), which classify gestures and produce actionable insights or commands.

The hardware integrates multiple communication protocols: Bluetooth for low-power, short-range connections; Wi-Fi for long-range, high-bandwidth connectivity; and USB/Serial for direct, high-speed data transfer. The power management components, especially IMU sensors, are optimized for low power use, ensuring long operational lifetimes. The system also includes battery monitoring and alerts for devices like Gesture Genius.

The software integration framework of the platform combines innovative technologies, modular subsystems, and robust communication protocols to deliver seamless and efficient gesture recognition, translation, and execution. Integration ensures smooth coordination across subsystems, hardware, and user interfaces while maintaining scalability, security, and reliability.

The platform integrates multiple subsystems that handle specific aspects of gesture recognition, processing, and command execution. Each subsystem interacts with others via APIs, ensuring consistent data exchange and processing for unified functionality: Text-to-Gesture Overlay (TGO): Converts text inputs into gesture overlays for applications such as video editing and real-time communication. Video-to-Gesture Overlay (VGO): Maps gestures to video content, enhancing accessibility and enabling gesture-based interactivity in media. Real-Time Text-to-Gesture Streaming (RTGS): Translates live text inputs into real-time gesture streams for virtual communication and accessibility. Gesture Cognition Engine (GCE): Available on the Rotational Stand and in the cloud, the GCE handles multi-modal input validation, gesture recognition, and anomaly detection, ensuring reliable system performance and user experience. Gesture Recognition to Text (GRT): Converts gesture inputs into natural language text, supporting accessibility tools like sign language translation. Multi-Agent Collaboration (MAC): Synchronizes gestures and commands across multiple devices or users, enabling collaborative workflows and interactions. Gesture Video Generation (GVG): Creates gesture-based videos for training, education, or interactive applications. Edge Computing Device Controller (ECDC): Acts as the bridge between the UI and the Rotational Stand, managing communication, command execution, and feedback in real time.
The platform's functionality is powered by a set of advanced machine learning models designed to handle gesture recognition, multi-modal fusion, and gesture-conditioned outputs. The core models include the Three-Stage Gesture Generative Multimodal Transformer (TGGMT), the Overlay Model, and the Video Generation Models (Motion, Point, and Gesture Video Gen). These models work in unison to deliver high accuracy and versatility across various gesture-based applications.
The TGGMT is the primary gesture recognition model that processes multi-modal data streams, including inputs from IMUs, cameras, and contextual sources. The model uses a three-stage training process: Multi-modal Transformer Training, which learns gesture representations from raw multi-modal inputs; Dataset Scoring and CutMix Augmentation, which enhances robustness by augmenting gesture datasets; and GPT-2 Integration, which incorporates natural language generation capabilities for gesture-to-text translation. Introduces a validation loss-driven augmentation strategy, dynamically adjusting Data Augmentation Module (DAM) levels (0-N) to optimize model generalization and prevent premature early stopping. This ensures progressive refinement of gesture recognition performance through incremental data augmentation tuning. Enhances gesture sequence learning by independently computing forward and reversed sequences, improving gesture recognition fluency and temporal accuracy.

TGGMT recognizes static, dynamic, and complex gestures, fusing multi-modal inputs for accurate interpretation. It generates gesture-conditioned text and commands in real time, ensuring seamless interactions and responses. This functionality is crucial for applications requiring high precision and responsiveness, such as accessibility tools and interactive media. Full TGGMT is deployed in the cloud for computationally intensive tasks like gesture-conditioned video generation, ensuring optimal performance and scalability. Optimized versions, such as DistilTGGMT, are deployed on edge devices for lightweight gesture recognition, providing flexibility and efficiency in various environments and use cases. The TGGMT uses edit accuracy thresholds to dynamically adjust model parameters, ensuring real-time performance optimization for both cloud and edge-deployed versions of TGGMT. It supports static, dynamic, and fingerspelling gestures, with adaptive configuration for token-level processing (word, character, phrase-based recognition), ensuring versatility across different application domains.

The Overlay Model translates gesture data into overlay outputs that enhance accessibility and interactivity in visual media. It works in conjunction with Text-to-Gesture Overlay (TGO) and Video-to-Gesture Overlay (VGO) subsystems. The Overlay Model dynamically maps recognized gestures to text or visual overlays and supports real-time updates to match gestures with live or pre-recorded video content. This model is essential for accessibility tools for hearing-impaired users, such as sign language overlays, interactive media, and presentations with gesture-based annotations.

The platform incorporates three specialized models for gesture-based video generation, enabling the creation of high-quality, context-aware animations or videos: The Motion-Based Video Generation Model synthesizes motion-based animations from gesture inputs, capturing motion patterns and generating videos that replicate realistic movements-ideal for applications like dance, fitness training, or motion analysis. The Point-Based Video Generation Model focuses on generating videos based on gesture landmarks and skeletal points, transforming point-based gesture data into realistic skeletal animations, and is useful for debugging gesture recognition systems or creating skeletal animations for educational purposes. The Gesture Video Generation Model produces high-fidelity videos of gestures for accessibility and training, capturing nuanced details of gestures, including finger movements and micro-gestures, and supports sign language training and gesture-based instruction.

User Interfaces: The platform supports both desktop applications and browser-based interactions. The ECDC ensures smooth communication between clients and hardware, providing intuitive control over gestures, commands, and system feedback. Cross-Platform Support: Compatible with multiple operating systems and browsers through the ECDC OS Driver and ECDC Browser Plugin.

The platform employs well-defined APIs for communication between subsystems and external applications, enabling extensibility and integration with third-party services. It utilizes communication protocols such as WebSocket and MQTT for real-time, low-latency communication between edge devices, cloud servers, and clients, as well as Bluetooth and Wi-Fi for direct communication between hardware components like the Rotational Stand and other connected devices.

Hybrid Processing Architecture ensures that lightweight recognition and gesture processing occur on edge devices using the ECDC and optimized models, while heavy computational tasks, such as video generation or federated model aggregation, are handled by cloud infrastructure. Subsystems continuously synchronize gesture mappings, model updates, and logs between edge devices and the cloud, supporting offline functionality by caching essential data locally on edge devices.

All data transmitted between components, including gesture inputs and recognition results, is secured with TLS encryption to ensure data integrity and confidentiality. The platform employs federated learning to improve models across devices without sharing raw user data, preserving user privacy. Access Control: Role-based access ensures that only authorized users and systems can interact with subsystems, APIs, and hardware components.

The software integration in the platform ensures seamless collaboration between subsystems like TGO, VGO, RTGS, GCE, GRT, MAC, GVG, and ECDC. With a robust TGGMT Core Model, secure APIs, and hybrid cloud-edge synchronization, the platform achieves high accuracy, scalability, and real-time responsiveness. Its privacy-conscious architecture and multi-platform compatibility make it adaptable for diverse applications ranging from accessibility tools to industrial automation.

The integration workflow is enhanced by distinguishing lightweight operations that run offline on edge devices from heavy processing tasks, such as video generation, which are executed online. Federated learning is implemented to train models across distributed edge devices without sharing raw data, ensuring privacy, and improving resource utilization. Additionally, resource sharing among edge devices is introduced for load balancing and optimized performance.

Step 1 (Input Capture): Sensors capture raw gesture data from devices such as Gesture Genius and PoseTrack. Inputs include IMU signals (e.g., accelerometer and gyroscope data), visual data for video processing (if enabled), and contextual data such as user location or device state. The Gesture Cognition Engine (GCE) preprocesses the captured data, including normalization, noise reduction, and feature extraction.

Step 2: (Task Categorization): Based on the type of operation, tasks are categorized into lightweight offline tasks or heavy online tasks: Lightweight Operations (Offline): Gesture recognition and command execution are performed locally using optimized, lightweight models (e.g., DistilTGGMT or optimized mobile versions of TGGMT). Low-latency operations, such as gesture-to-command translation and real-time interaction, are handled entirely on the edge device. Heavy Processing Tasks (Online): Tasks requiring significant computational resources, such as video generation or long video generation, are offloaded to cloud servers. These tasks leverage the full capabilities of the TGGMT Core Model in its original or expanded form, ensuring the highest accuracy and quality.

Step 3 (Offline (Edge-Based) Processing): Lightweight versions of TGGMT, such as DistilTGGMT, are deployed on edge devices to handle tasks efficiently. Low-Latency Execution: Commands such as gesture recognition, mapping, and execution are processed locally with minimal delay. Resource Sharing: Idle edge devices within a local network can share computational tasks to balance loads. For example, if a nearby device has higher processing power, it can assist another device by taking on a portion of its workload. Example: A mobile device offloads parts of gesture recognition preprocessing to a more powerful desktop within the same network.

Step 4 (Online Cloud-Based Processing): Tasks requiring substantial computational power, such as video generation, rendering gestures into animations, or creating extended gesture-based videos, are delegated to cloud servers to manage the high processing demands. The system transmits preprocessed data from the edge device to the server using secure WebSocket or MQTT protocols. Model Updates: The latest TGGMT model updates are maintained in the cloud and periodically synchronized with edge devices for improved offline performance. Advanced Analytics: Cloud infrastructure supports complex analytics, such as training updates, performance metrics, and aggregate usage statistics.

Step 5 (Federated Learning): Each edge device trains a local instance of the model using its collected data, such as user gestures. Only the model updates (e.g., gradients or weights) are sent to the central server, not raw data, preserving privacy. Server Aggregation: The central server aggregates updates from all edge devices to refine a global model, which is then redistributed to all devices. Example: A mobile device in one location trains the model on localized gesture data. These updates are combined with updates from other devices to improve global recognition accuracy without compromising individual data privacy.

Step 6: Command Execution: Recognized gestures are mapped to specific commands using a gesture-to-command mapping database. Offline commands are executed directly by the edge device, such as controlling a rotational stand or triggering a desktop application. Meanwhile, online commands requiring cloud infrastructure, like video rendering or collaborative applications, are processed on the server, with the results sent back to the edge device or client. This distribution ensures efficiency and precision in handling various tasks. Offline (Edge-Based) Advantages: Low Latency: Real-time recognition and command execution with no reliance on network connectivity. Privacy: Sensitive data (e.g., gestures or video) is processed locally, preventing unnecessary exposure to external servers. Cost Efficiency: Reduces dependency on cloud infrastructure, lowering bandwidth and operational costs. Resource Sharing: Edge devices in a local network can collaborate to optimize performance and handle distributed tasks efficiently. Online (Cloud-Based) Advantages: High Computational Power: Heavy processing tasks such as video generation are performed on powerful cloud servers, ensuring high quality and accuracy. Centralized Model Refinement: Continuous updates to the TGGMT Core Model provide access to the latest capabilities for all devices. Scalability: Cloud infrastructure can support many simultaneous users or devices. Advanced Analytics: Centralized analysis of gesture patterns enables better insights and improvements to system performance.

Lightweight optimized models, such as DistilTGGMT, ensure high efficiency for edge devices without compromising recognition accuracy. These models are tailored to the processing constraints of mobile and embedded devices. Additionally, a distributed task management system allows edge devices to offload parts of their workloads to other edge devices within a local network, improving processing efficiency and extending battery life for resource-constrained devices. Federated learning enhances privacy and enables personalization based on local data by training models on edge devices without sharing raw data. The server aggregates these updates to refine the global model. Furthermore, tasks are dynamically routed to either edge or cloud environments based on their complexity, resource requirements, and the availability of network connectivity.

The Gesture Transformer Combined Score is a performance evaluation metric used in the Three-Stage Gesture Generative Multimodal Transformer (TGGMT), integrating multiple factors to assess the accuracy, reliability, and efficiency of the gesture recognition process. Instead of relying on a single metric, such as raw recognition accuracy, the Combined Score considers Edit Accuracy Contribution, which measures how closely the recognized gesture sequence matches the correct gesture sequence, and Edit Distance Penalty, which accounts for the difference between the predicted and actual gestures, reducing the score if mismatches occur. Additionally, Loss Metrics Impact includes both total model loss and auxiliary loss to penalize unstable or high-loss predictions, while the Threshold Success Factor adds weight to successful gesture recognitions that meet predefined performance thresholds, ensuring that high-quality predictions are prioritized. The system dynamically balances these factors using weighted coefficients, adjusting for real-world variations in gesture recognition, and the final normalized score is restricted within a specific range to maintain stability and consistency across different environments.

Per-Sample GPT Edit Accuracy, also known as the Similarity Score, evaluates the accuracy of the model's predicted gesture output by comparing each recognized gesture to the intended gesture on a per-sample basis. It measures how closely the generated sequence matches the expected sequence by assessing the required changes, such as insertions, deletions, and substitutions. This metric accounts for minor acceptable variations in gestures while penalizing significant mismatches, thus ensuring higher similarity scores for identical outputs and lower scores for considerable differences. This continuous evaluation helps refine gesture predictions in real-time, improving context, accuracy, and user adaptability.

The Distance with Weighted Contributions method evaluates the differences between a predicted gesture sequence and the correct (ground truth) sequence, while considering the relative importance of several types of errors. Instead of treating all errors equally, this approach assigns different weights to several types of mismatches, ensuring a more context-aware assessment of gesture accuracy. Firstly, the system identifies mismatches by detecting where the predicted gesture deviates from the correct one. These deviations include insertions (extra gestures), deletions (missing gestures), and substitutions (incorrect gestures). Next, it applies weight adjustments, assigning different weights to several types of errors based on their impact on overall recognition quality. For instance, critical errors, such as deleting essential gestures, are penalized more heavily, whereas minor variations, such as slight timing shifts, may have a lower impact on the score. Finally, the system combines these factors into a final distance score, aggregating the weighted contributions from different mismatch types. This method balances precision and flexibility by allowing minor variations while penalizing significant errors. It enhances real-world performance by ensuring the model adapts to natural variations in human gestures, and it supports model fine-tuning by providing a more detailed breakdown of errors, allowing adjustments to improve accuracy.

Edit Accuracy measures how closely a predicted gesture sequence matches the correct (ground truth) sequence by evaluating the minimum number of changes needed to correct the prediction. It is commonly used in gesture recognition, text processing, and sequence-based AI models to quantify performance. The process involves comparing the predicted sequence to the expected sequence to identify differences. The system then counts the necessary modifications, determining the number of insertions, deletions, and substitutions required to transform the predicted sequence into the correct sequence. It computes the similarity, where a higher Edit Accuracy indicates fewer modifications were needed, signifying a closer match to the expected result. This metric is important as it helps fine-tune gesture models by identifying how well the system is learning gestures. It balances flexibility and precision by allowing minor acceptable variations while penalizing major errors. Moreover, it supports real-time adaptation by enabling models to adjust based on observed performance over time.

The TGGMT Combined Score is an aggregated metric that evaluates the overall performance of the Three-Stage Gesture Generative Multimodal Transformer (TGGMT) by combining multiple accuracy assessments. It provides a holistic evaluation of gesture recognition quality, ensuring that various aspects of the model's output are considered. The combined score is derived from three key measurements. Firstly, GPT Edit Accuracy measures how well the generated text or gesture sequences align with expected outputs by evaluating the necessary modifications such as insertions, deletions, and substitutions. This metric ensures that language-based gesture interpretations are contextually accurate. Secondly, Hybrid Transformer Edit Accuracy assesses the accuracy of gesture-to-text and text-to-gesture transformations by analyzing how well the model preserves structural integrity across different modalities. This guarantees that the system accurately maps gestures to linguistic constructs and vice versa. Finally, Overall Edit Accuracy provides a global assessment by integrating multiple error sources and considering both token-level and sequence-level modifications to determine the final accuracy score. This comprehensive approach is important for several reasons. It improves model adaptability by considering multiple accuracy metrics, allowing the model to dynamically adjust its learning strategies to optimize real-world performance. It also enhances decision-making by helping to prioritize high-confidence predictions while allowing for controlled refinements based on validation trends. Lastly, it balances multi-modal performance, ensuring gesture recognition quality across different transformations.

The TGGMT Core Model achieves unparalleled performance by synergizing gesture recognition with language generation, leveraging multi-modal data streams, and improving robustness through advanced augmentation techniques. This makes it adaptable to diverse scenarios and ensures reliable, high-accuracy gesture recognition and communication in real-world applications.

### BRIEF DESCRIPTION OF THE FIGURES

In the accompanying illustrations, similar reference characters are used to denote similar parts across various views. It is also important to note that the drawings are not necessarily to scale, as the primary objective is to clearly convey the principles of the disclosed technology. The figures illustrate the system architecture, functional modules, and data flow of the integrated platform-also referred to as Inclusive GPT. These drawings collectively describe the core components and operational mechanisms of Inclusive GPT, including gesture recognition, multi-modal transformation, federated learning integration, privacy-preserving techniques, and adaptive generation pipelines. In the following discussion, various implementations of the disclosed technology are explained with reference to the following figures:

FIG. 1 illustrates the Image Samples Data Generation Methodology 100, providing a systematic approach for generating high-quality gesture data samples. This process includes multi-modal data capture, preprocessing, augmentation, and storage strategies to ensure robust training datasets for gesture recognition models.

FIG. 2 illustrates the Gesture Recognition Process Flow Diagram 200, detailing the end-to-end steps involved in recognizing, processing, and interpreting gestures into text through an advanced multi-modal architecture that integrates sensor data, AI-based gesture mapping, and contextual understanding.

FIG. 3A illustrates a block diagram of the Rotational Stand 300, a multifunctional device designed for independent gesture recognition, processing, and execution. The diagram highlights key functional components, including computer vision modules, multi-sensor input arrays, and AI-powered gesture processing units. These components work in unison to enable touchless interaction, motion tracking, and real-time command execution across diverse applications.

FIG. 3B presents a line drawing of the physical form of the Rotational Stand 300, illustrating its hardware layout and mechanical design. The illustration includes structural features such as the rotating base, sensor placements, and gesture detection zones, demonstrating how the form factor supports a stable platform for intuitive, AI-driven interaction in real-world use cases.

FIG. 4A illustrates a block diagram of the Gesture Genius 400, a lightweight, mobile device engineered for advanced gesture recognition and real-time communication. The diagram details its core functional components, including multi-sensor input arrays, inertial measurement unit (IMU) tracking, embedded AI processing, and wireless connectivity modules. These elements collectively enable the device to capture, interpret, and transmit gesture data with high precision and responsiveness in dynamic environments.

FIG. 4B shows a line drawing of the Gesture Genius 400, highlighting its compact form factor and sensor placement. The illustration includes external hardware features such as camera sensors, motion tracking modules, and interface ports, demonstrating the device's portability and ergonomic design optimized for hands-free operation and on-the-go accessibility use cases.

FIG. 5 presents a distributed and modular architecture design for a gesture recognition, processing, and output framework. It integrates multiple services and components, ensuring seamless data flow, real-time gesture-based interactions, and performance monitoring. The system centralizes gesture interpretation and decision-making through the RAG-Enhanced Service 588 for enhanced adaptability and contextual accuracy.

FIG. 6A provides a front-left perspective view of the Gesture Genius and Rotational Stand Prototype 600, illustrating the physical integration and spatial alignment of the Gesture Genius 628 with the Rotational Stand Device 624. This angled view highlights how the devices are designed to work in tandem, with optimal sensor placement, rotation alignment, and field-of-view orientation that enable enhanced gesture detection and adaptive interaction in real-world settings.

FIG. 6B presents a direct front view of the Gesture Genius and Rotational Stand Prototype 600, focusing on the symmetry and alignment between the two components. This view emphasizes the ergonomic positioning of the Gesture Genius atop the Rotational Stand, showcasing how the configuration ensures stable base rotation and gesture input precision, thereby supporting seamless, touchless user experiences.

FIG. 7 illustrates the SQL Database 700, which serves as the primary structured data repository, facilitating efficient storage, retrieval, and management of essential system information, including user profiles, configuration settings, and gesture mappings.

FIG. 8 illustrates the Vector Database 800, which stores high-dimensional gesture embeddings for efficient similarity searches, AI model optimization, and real-time gesture classification.

FIG. 9 illustrates the NoSQL Database 900, which manages unstructured and real-time gesture data, enabling quick processing, monitoring, and debugging for system-wide gesture recognition and command execution workflows.

FIG. 10 illustrates a block diagram of PoseTrack (1000), a comprehensive lower and upper body motion tracker. It features a first electronic device integrated with a Universal Asynchronous Receiver-Transmitter (UART) device, ensuring real-time motion tracking, dual-device synchronization, and efficient multi-channel IMU data processing.

FIG. 11 illustrates a block diagram of the overall system architecture (1100), providing a high-level view of the components shown in FIG. 5. It demonstrates how multiple services and components are integrated to ensure seamless data flow, real-time gesture-based interactions, and effective performance monitoring.

### DETAILED DESCRIPTION OF FIGURES

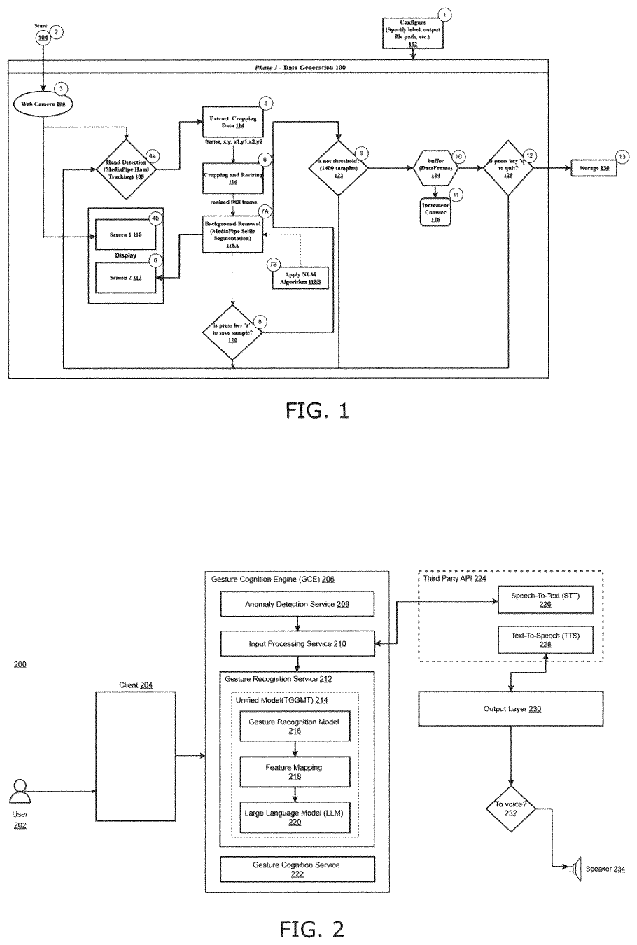

Referring to FIG. 1, the Image Samples Data Generation Methodology 100, providing a comprehensive and systematic approach for generating high-quality gesture data samples. This methodology incorporates a novel application of the Non-Local Means (NLM) algorithm for noise removal, which significantly enhances the clarity and usability of the captured data. It is designed to produce robust datasets that are suitable for training and validating gesture recognition systems. The process begins with the Configuration Input File 102, which allows users to define critical parameters such as image resolution, the total number of samples required, the application of noise removal techniques, and the desired storage format. These configurations ensure that the data collection aligns with specific project requirements and maintains consistency across samples. The system is initialized via Start 104, triggering the Web Camera 106 to capture live gesture frames. These frames are processed in real time through Hand Detection 108, powered by MediaPipe Hand Tracking, which detects and isolates hand landmarks. This ensures that only the regions of interest are captured, reducing computational overhead, and increasing the accuracy of subsequent steps. Real-time visual feedback is provided through Visualization Screen 1 110 and Visualization Screen 2 112, which display the raw camera feed alongside overlaid hand landmarks for user verification. This feedback ensures that the captured data meets quality expectations before being saved. After hand detection, the system proceeds to Extract Cropping Data 114, isolating the region around the detected hand. This data is then normalized through Cropping and Resizing 116, which standardizes the dimensions of the samples to ensure uniformity.

A novel enhancement in this methodology is the integration of Background Removal 118A technique and the application of the Non-Local Means (NLM) Algorithm 118B for image noise removal. The NLM algorithm applies optimal parameters to denoise the images, preserving essential gesture details while eliminating noise artifacts caused by lighting inconsistencies, sensor imperfections, or environmental factors. This step significantly improves the clarity and quality of the gesture samples, making them more suitable for machine learning models and real-time processing. Throughout the process, the system evaluates user-controlled conditions. If the ‘z’ key 120 is pressed, the sample is temporarily saved to the Buffer (DataFrame) 124 for further processing or review. The system also monitors the total number of samples collected, ensuring the threshold of 1400 samples 122 is met before completing the session. If the sample count is below the threshold, the process continues until the required number of samples is achieved. The system also allows the user to terminate the data collection session at any time by pressing the ‘q’ key 128, providing operational flexibility. Once the session concludes, the collected data is transferred to Storage 130, adhering to the preconfigured file format and organizational structure. This methodology's key novelty lies in the application of the Non-Local Means algorithm, which, when combined with advanced tracking and segmentation techniques, ensures the generation of high-quality gesture datasets. This approach addresses common challenges such as noise, background clutter, and inconsistencies, making it a critical tool for building accurate, robust gesture recognition models.

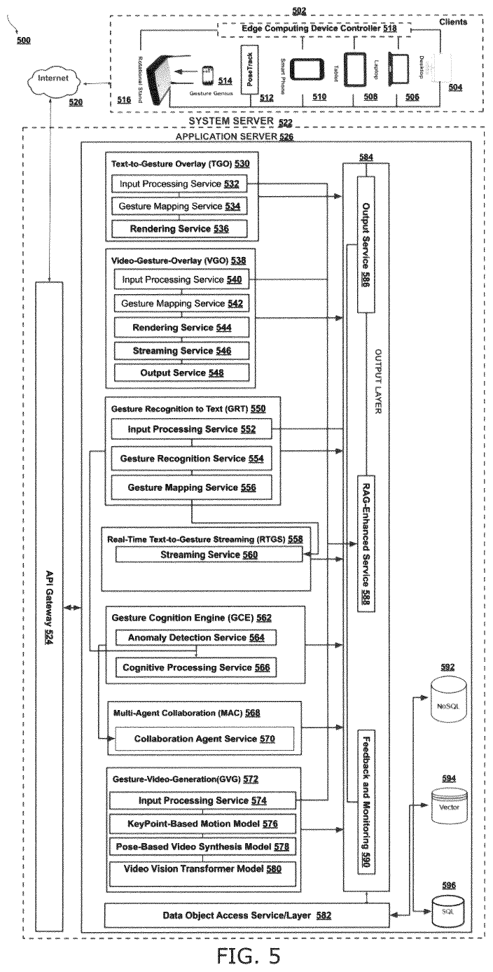

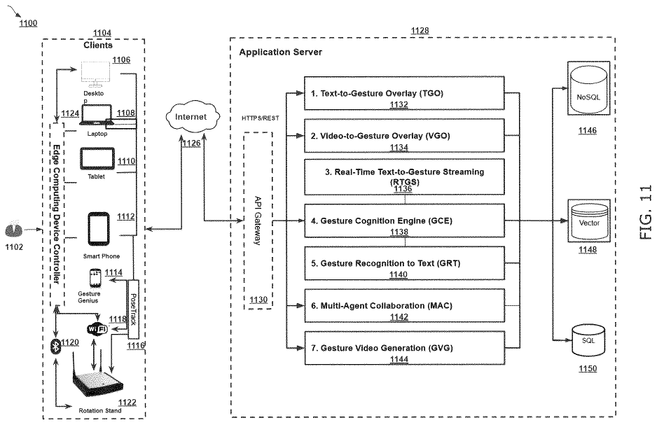

Referring to FIG. 2, the Gesture Recognition Process Flow Diagram 200, detailing the comprehensive steps involved in recognizing, processing, and interpreting gestures into text through an advanced multi-modal architecture. This system integrates diverse data sources, sophisticated AI models, and real-time processing mechanisms to enhance gesture-based interactions. The process begins with the User 202, who performs a gesture intended for recognition. The user's interaction is captured through the Client 204, which serves as the primary interface for data acquisition, processing, and output visualization. The details of the client components and interaction layers will be discussed further in FIG. 5. and FIG. 11. At the core of the recognition process is the Gesture Cognition Engine (GCE) 206, which is responsible for processing data input, identifying anomalies, recognizing gestures, and mapping them to meaningful outputs. Within GCE, the Anomaly Detection Service 208 continuously monitors input data streams to identify inconsistencies or unusual patterns that may degrade recognition accuracy. If an anomaly is detected, it is flagged for further processing or correction. The Input Processing Service 210 is responsible for handling multiple data modalities, including image, visual landmarks, text, audio, and sensor data (e.g., IMU, accelerometer, or other motion sensors). This multi-modal integration ensures that gestures are recognized with higher accuracy and robustness across various environments. The processed data is then fed into the Gesture Recognition Service 212, which comprises multiple AI-driven components. The primary recognition framework is the Three-Stage Gesture Generative Multimodal Transformer (TGGMT) 214, also referred to as the Unified Model. The Gesture Recognition Model 216 operates within this framework, utilizing deep learning architectures such as CNNs, RNNs, and Transformers to accurately detect static and dynamic gestures. The Feature Mapping Module 218 converts gestures into character-or word-level outputs, providing configurable granularity for different applications. Additionally, the Large Language Model (LLM) 220 enhances contextual understanding by mapping recognized gestures to meaningful textual representations, improving the overall accuracy and usability of the system.

To further refine the recognition process, the Gesture Cognition Service 222 is integrated within the GCE, providing higher-order reasoning, adaptive learning mechanisms, and real-time adjustments to improve user interaction. For extended functionality, the system interfaces with Third-Party APIs 224, which facilitates additional processing and accessibility features. The Speech-To-Text (STT) Service 226 enables real-time conversion of spoken language into text for gesture-based input augmentation, while the Text-To-Speech (TTS) Service 228 allows gesture-based commands or recognized sign language phrases to be converted into spoken language, providing accessibility support for individuals with hearing impairments. Once the gesture is fully processed, it is forwarded to the Output Layer 230, which determines the appropriate output format based on the use case. The specifics of the Output Layer will be discussed in FIG. 5. and FIG. 11. If the system determines that the output should be converted into voice (evaluated using the Text-to-Voice Condition 232), the result is sent to the Speaker 234, where the converted voice output is played for auditory feedback. This flow diagram showcases the advanced AI-driven multi-modal approach of the system, integrating real-time gesture recognition; anomaly detection, large language models, and external APIs to create a seamless and intuitive gesture-based communication platform. The system's flexibility allows for its use in accessibility technology, human-computer interaction, virtual assistants, automation, and other domains that require hand-free control and interaction.

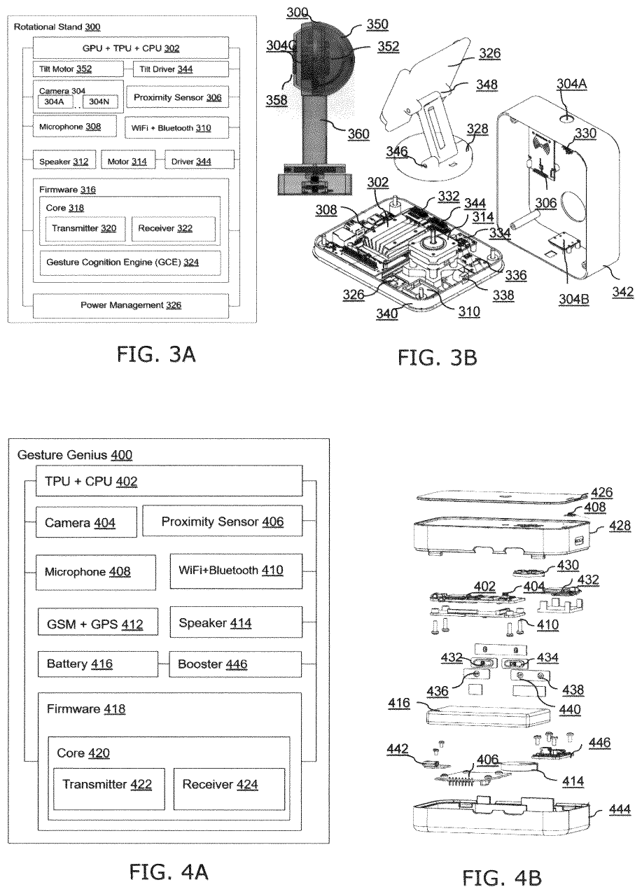

FIG. 3A illustrates a block diagram of the Rotational Stand 300, highlighting its internal architecture and core functional components for gesture recognition, processing, and execution. At the center of the system is the Processing Unit 302, which includes a combination of GPU, TPU, and CPU cores. This heterogeneous architecture enables efficient management of video input, gesture recognition, and machine learning inference

The Camera Array 304A to 304N captures gesture movements, facial expressions, and body positioning from multiple angles to ensure high-fidelity visual input. Proximity Sensor 306 provides user detection and supports context-based activation to optimize energy usage. The Microphone 308 supports hybrid audio-gesture interaction, while the Wi-Fi+Bluetooth Module 310 ensures robust wireless communication with edge devices and cloud platforms. Speaker 312 enables real-time auditory feedback and alerts.

The Rotation Motor 314 facilitates the directional rotation of the stand for tracking dynamic gestures. Firmware 316 governs the device's real-time coordination and system updates. The Core Module 318 serves as a control interface, integrating sensory inputs and command outputs. The Transmitter 320 and Receiver 322 support bidirectional communication between the stand and external systems.

Central to this block architecture is the Gesture Cognition Engine (GCE 324), which processes multimodal inputs (visual, IMU, proximity, etc.) and applies Perennity AI's proprietary Three-Stage Gesture Generative Multimodal Transformer (TGGMT) for context-aware, high-accuracy gesture classification and anomaly detection. Finally, the Mobile Device Holder 326 provides structural accommodation for tablets or smartphones used in gesture-controlled applications.

FIG. 3B presents a line drawing of the physical configuration of the Rotational Stand 300, offering a detailed view of its mechanical and external hardware components. The Rotation Motor Hub 328 provides the foundational structure for rotational movement. The Power Button 330 allows users to manually start or shut down the device. The Tilt Motor Driver 332 enables vertical angular control, and the IMU 334 (Inertial Measurement Unit) captures movement orientation for accurate positioning and gesture stabilization.

Connectivity is provided via USB Type A 336 and DC Power Socket 338, offering both power and data interfaces. The Case Base 340 and Case Cover 342 encase and protect the internal components while ensuring structural integrity. The Rotation Motion Driver 344 governs rotational mechanics, while the Holder Height Adjustment Shaft 346 and Holder Vertical Adjustment Shaft 348 allow ergonomic positioning of devices for various user scenarios.

The upper tracking unit includes the Ball Head Enclosure 350, which integrates a Tilt Motor 352 for vertical adjustments and a Camera 304C for secondary visual input. It also includes an LED Ring 358 to provide illumination in low-light environments. These are mounted onto a Ball Head Pole 360, which offers vertical tracking stabilization and structural support. This physical design enables the system to dynamically adjust to users'positions, enhancing real-time gesture capture and interaction.

FIG. 4A presents a block diagram of the Gesture Genius 400, a compact, portable device optimized for gesture recognition, hybrid interaction, and real-time communication. At the core is the TPU+CPU 402 unit, which combines a Tensor Processing Unit (TPU) for high-speed machine learning inference and a Central Processing Unit (CPU) for system control, data integration, and device management. This combination enables real-time gesture classification, anomaly detection, and contextual command processing with low latency.

The Camera 404 captures detailed hand and body movements, serving as the primary visual input for gesture recognition. The Proximity Sensor 406 enhances contextual awareness, enabling the device to wake from idle or conserve power based on user presence. It also supports gesture command transfer between nearby devices. The Microphone 408 allows voice-gesture hybrid interaction, and its built-in noise-aware processing improves recognition accuracy in dynamic audio environments.

For wireless communication, the Wi-Fi+Bluetooth Module 410 provides seamless connectivity to edge devices and cloud infrastructure, while the GSM +GPS Module 412 supports mobile operation and geolocation, allowing gesture-driven tasks to be performed anywhere. The Speaker 414 delivers real-time feedback through voice alerts and confirmations. The Battery 416, supported by a Power Management Booster 446, ensures extended operation with optimized power consumption for each module.

The Firmware 418 governs real-time control, system updates, and secure boot sequences, while the Core 420 acts as the integration and coordination engine, directing data between sensors, processing units, and communication interfaces. The Transmitter 422 sends processed gesture data to external systems or cloud platforms, while the Receiver 424 receives commands, data packets, and updates from external sources, enabling bidirectional data flow.

Together, these components create a self-contained, AI-powered gesture recognition device, capable of operating independently or as part of a larger gesture-enabled network.

FIG. 4B illustrates a line drawing of the Gesture Genius 400, detailing its external physical structure and interface elements. The Front Glass Cover 426 and Front Cover 428 offer both durability and clarity for visual sensors while maintaining an aesthetic and ergonomic appearance. The LED Ring 430 provides real-time visual feedback, glowing in different patterns or colors based on system status, gesture activity, or alerts.

On the body, hardware buttons support intuitive control. These include the Power Button 432, Start Button 434 to initiate recognition sessions, Mute Button 436, Volume Up Button 438, and Volume Down Button 440 for audio control. The Female USB Type C Port 442 offers fast charging and data transfer with external systems or accessories.

The GSM +GPS Module 432 is embedded within the body and enhances network and location-based services, allowing the Gesture Genius to function seamlessly in mobile environments. The Back Cover 444 houses and protects the internal hardware, battery, and sensor systems, while ensuring a lightweight and mobile-friendly design.

This external layout is optimized for on-the-go usability, allowing the device to be easily carried, mounted, or integrated into enterprise workflows across accessibility, healthcare, education, industrial environments, etc.

Referring to FIG. 5, presents a distributed and modular architecture design for a gesture recognition, processing, and output framework. It integrates multiple components and services to provide real-time gesture-based interactions across a variety of client devices and subsystems. The system ensures seamless integration, data flow, and performance monitoring through the output layer, with a centralized reliance on RAG-Enhanced Service 588 for enhanced functionality. The system supports a diverse range of client devices, including desktops, laptops, tablets, and smartphones, which serve as user interaction points for input and output (Clients 502). These devices connect to edge devices such as PoseTrack 512, Gesture Genius 514, and the Rotational Stand 516. PoseTrack tracks upper and lower body gestures using IMU and sensor data, Gesture Genius captures and transfers gesture data via proximity and IMU sensors, and the Rotational Stand independently captures gestures, performs local processing, and updates outputs. The Edge Computing Device Controller (ECDC 518) acts as the bridge between clients and edge devices, enabling real-time command execution and data synchronization. Internet connectivity (520) ensures seamless communication between edge devices and the System Server 522, facilitating cloud-dependent processing and advanced functionalities.

The server-side components form the backbone of the system, starting with the System Server 522, which acts as the central processing unit hosting multiple subsystems to ensure efficient data handling and seamless coordination between components. The API Gateway 524 manages API requests, providing secure and optimized communication between clients, edge devices, and subsystems. Complementing these is the Application Server 526, which hosts subsystem-specific services, including gesture recognition, video generation, gesture overlays, and multi-agent collaboration, ensuring reliable execution of all system functionalities.

Each subsystem contributes to the overall functionality by integrating Input Processing Services and feeding into a shared output layer connected to the RAG-Enhanced Service 588, ensuring cohesive and context-aware performance.

Text-to-Gesture Overlay (TGO) 530 is designed to process textual inputs and convert them into gesture overlays. It uses the Input Processing Service 532 to analyze text, the Gesture Mapping Service 534 to associate text with gestures, and the Rendering Service 536 to create the gesture overlays. These overlays are delivered to clients via the Output Service 586, while the RAG-Enhanced Service 588 ensures context-aware mappings, supported by Feedback and Monitoring 590 for performance evaluation.

Video-to-Gesture Overlay (VGO) 538 focuses on processing video inputs for gesture overlays. The Input Processing Service 540 analyzes video frames, the Gesture Mapping Service 542 converts frames to gesture sequences, and the Rendering Service 544 applies the overlays. The Streaming Service 546 enables real-time streaming, and the processed outputs are connected to downstream services via the Output Layer.

Gesture Recognition to Text (GRT) 550 processes gesture data inputs through the Input Processing Service 552, recognizes gestures using the Gesture Recognition Service 554, and maps these gestures to textual outputs via the Gesture Mapping Service 556.

Real-Time Text-to-Gesture Streaming (RTGS) 558 combines the functionality of GRT 550 with a Streaming Service 560 to facilitate real-time text-to-gesture conversion, ensuring seamless delivery through the shared Output Layer.

Gesture Cognition Engine (GCE) 562 enables advanced gesture processing and decision-making. It incorporates the Anomaly Detection Service 564 to identify inconsistencies in gesture input, the Input Processing Service 552 to handle incoming data, and the Gesture Recognition Service 554 for identifying gestures, while the Cognitive Processing Service 566 enhances decision-making capabilities for gesture cognition tasks.

Multi-Agent Collaboration (MAC) 568 extends the GCE by introducing the Collaboration Agent Service 570, which coordinates multi-agent tasks, leveraging the Anomaly Detection Service 564 and other core services for synchronized collaboration.

Gesture Video Generation (GVG) 572 specializes in creating gesture-based video outputs. The Input Processing Service 574 manages gesture data input, while the KeyPoint-Based Motion Model 576 generates skeletal motion. The Pose-Based Video Synthesis Model 578 translates this motion into video frames, further enhanced by the Video Vision Transformer Model 580, which uses AI to produce high-quality gesture videos. Each subsystem contributes to the broader ecosystem by integrating seamlessly with the shared output layer, enhancing efficiency, and ensuring robust multi-modal functionality.

The Output Layer is a shared component across all subsystems, ensuring standardized processing and delivery of results. It begins with the Input Processing Service 532, which prepares data for downstream tasks. The Gesture Mapping Service 534 then maps gestures to actionable outputs, while the Rendering Service 536 visualizes gesture-based overlays and videos. The processed results are managed and delivered by the Output Service 586, with the RAG-Enhanced Service 588 adding critical context-aware enhancements to all gesture-related tasks. Finally, the Feedback and Monitoring 590 component tracks subsystem performance and user interactions, enabling iterative improvements for all processes.

The architecture in FIG. 5 demonstrates a modular design where all components interact seamlessly through shared services. The centralized RAG-Enhanced Service 588 ensures context-aware enhancements across all subsystems, enabling efficient and accurate processing of gesture-based data. This shared and refined approach optimizes the system's performance, ensuring robust and scalable functionality across all subsystems.

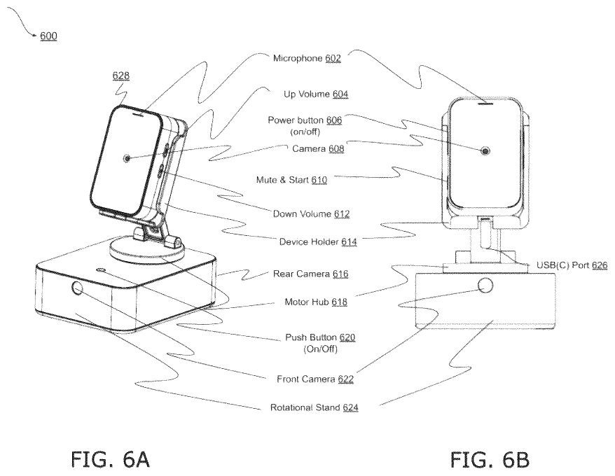

FIG. 6A illustrates a front-left perspective view of the Gesture Genius and Rotational Stand Prototype 600, highlighting the physical integration and spatial configuration of the Gesture Genius 628 with the Rotational Stand Device 624. This view demonstrates the ergonomic placement of components for optimal interaction and gesture tracking from multiple angles.

The Gesture Genius Microphone 602 is positioned to capture voice inputs that complement gesture-based commands, enabling hybrid interaction. Located on the left side are the Up Volume Button 604 and Down Volume Button 612, which allow the user to manually adjust audio output levels. The Gesture Genius Camera 608, placed near the front, captures real-time visual data of hand, finger, and body movements, enabling accurate gesture recognition.

The Rotational Stand Device Holder 614 securely holds the Gesture Genius in position, ensuring consistent tracking and alignment with the user. The Rotational Stand Rear Camera 616 enables backward-facing gesture tracking, complementing the front-facing sensor for 360-degree coverage. At the base, the Rotational Stand Motor Hub 618 supports automated rotational movement to follow user positioning. The Rotational Stand Push Button 620 is available for manually turning the motorized stand on or off. The Front Camera 622 captures frontal gestures and facial expressions to ensure holistic recognition. Together, this integrated configuration supports fluid, multi-angle gesture tracking and dynamic positioning for adaptive interaction.

FIG. 6B provides a direct front view of the Gesture Genius and Rotational Stand Prototype 600, emphasizing the symmetry and alignment of key user-facing components. This view captures the frontal layout of controls and sensors essential for direct interaction and usability.

The Gesture Genius Microphone 602 remains central for capturing clear audio input.

The Power Button (On/Off) 606 is located in an easily accessible position, enabling quick activation or shutdown of the device. The Gesture Genius Mute & Start Button 610 offers dual functionality: muting audio output and initiating gesture recognition manually when needed.

The Gesture Genius Type-C USB Port 626 is positioned on the front-facing lower edge, providing connectivity for data transfer and charging. This supports seamless synchronization with external devices and ensures sustained power supply. The Rotational Stand Device Holder 614 continues to provide stable mounting for the Gesture Genius, while the Rotational Stand Motor Hub 618 is visible at the base, anchoring the unit and enabling rotational movement. The Front Camera 622, embedded in the stand, aligns directly with the user for accurate and uninterrupted frontal gesture tracking.

Together, this view emphasizes how the Gesture Genius and Rotational Stand operate in unison, providing a cohesive, touchless interface that integrates visual, auditory, and positional sensing technologies in a user-friendly, vertically integrated form factor.

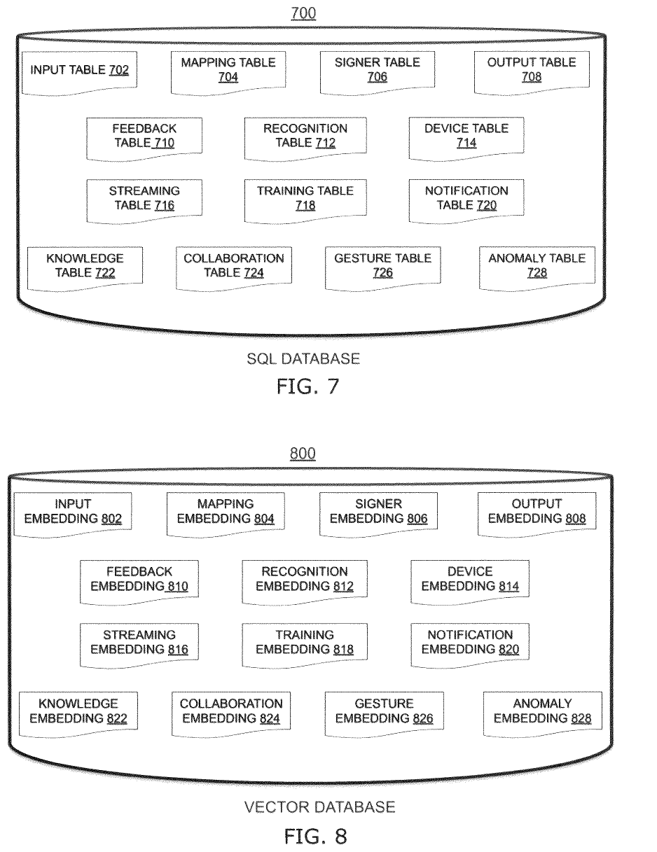

Referring to FIG. 7, illustrated the SQL Database 700, which functions as the primary repository for structured data within the system, facilitating efficient storage, retrieval, and management of essential information. The Input Table 702 captures data inputs from various sources, such as user interactions and devices. The Mapping Table 704 manages gesture-to-command and gesture-to-output mappings to support accurate processing. The Signer Table 706 maintains signer profiles and preferences for personalized gesture overlays. The Output Table 708 stores details of generated outputs, including gestures, videos, and command executions. The Feedback Table 710 logs user feedback to monitor system performance and identify areas for improvement. The Recognition Table 712 records gesture recognition results and associated metadata. The Device Table 714 tracks registered devices, including configurations and statuses. The Streaming Table 716 manages live streaming sessions and configurations. The Training Table 718 stores training job details, metrics, and models. The Notification Table 720 tracks system-generated notifications and their delivery statuses. The Knowledge Table 722 holds structured knowledge base entries for retrieval-augmented generation tasks. The Collaboration Table 724 tracks multi-agent collaboration sessions and tasks. The Gesture Table 726 stores gesture definitions, metadata, and features. Finally, the Anomaly Table 728 records detected anomalies, their types, and resolution statuses, ensuring robust monitoring and issue tracking across the system. Together, these tables form a cohesive database architecture that underpins the system's functionality and ensures data consistency and accessibility.

Referring to FIG. 8, illustrated the Vector Database 800, which stores high-dimensional embeddings for efficient similarity searches, machine learning optimization, and real-time AI processing. The Input Embeddings 802 represents input data, enabling fast and accurate retrieval of relevant features for gesture recognition and processing. The Mapping Embeddings 804 store vectorized mappings between gestures and their associated commands or outputs, improving lookup efficiency. The Signer Embeddings 806 contains personalized signer preferences and characteristics, facilitating adaptive gesture overlays. The Output Embeddings 808 represents generated outputs, such as gestures or commands, for refined post-processing and tracking. The Feedback Embeddings 810 vectorize user feedback to help refine model accuracy and system personalization. The Recognition Embeddings 812 store gesture recognition features to improve system accuracy through advanced AI models. The Device Embeddings 814 capture device-specific configurations and metadata to enhance interoperability. The Streaming Embeddings 816 vectorize streaming session data, ensuring efficient tracking and optimization for real-time interactions. The Training Embeddings 818 represents training data and associated metadata, optimizing AI model improvements. The Notification Embeddings 820 store contextual details about notifications to personalize user alerts. The Knowledge Embeddings 822 represents entries in the knowledge base, enabling retrieval-augmented generation for context-aware outputs. The Collaboration Embeddings 824 vectorize multi-agent collaboration session data to optimize decision-making and task allocation. The Gesture Embeddings 826 represents gesture features and motion patterns for advanced analysis and synthesis. Lastly, the Anomaly Embeddings 828 store vectorized features of detected anomalies, enabling precise anomaly detection and resolution. Together, these embeddings ensure high performance, scalability, and contextual understanding across the platform.

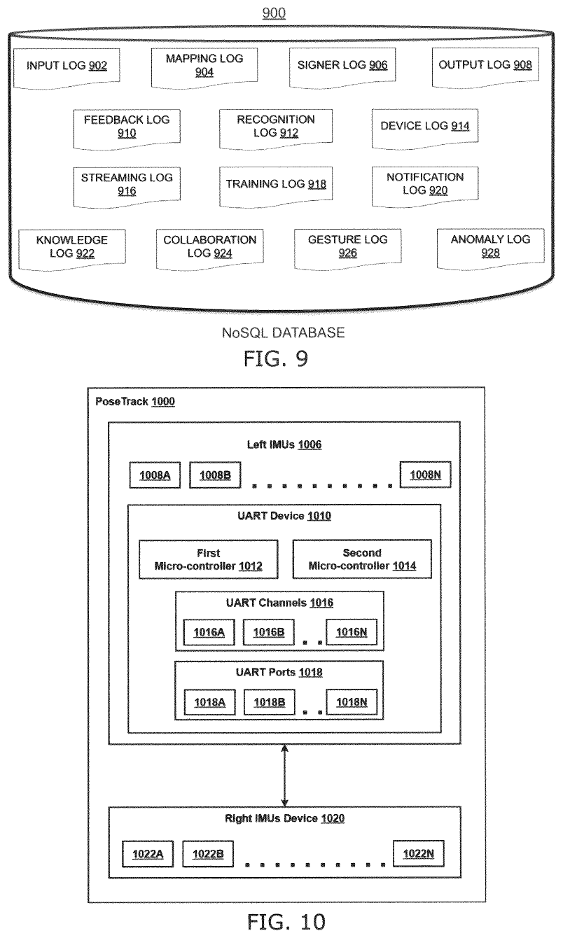

Referring to FIG. 9, illustrated the NoSQL Database 900 which stores and manages unstructured, real-time data for quick processing, monitoring, and debugging. The Input Logs 902 capture raw input data streams and events, providing a comprehensive history of user interactions and device inputs. The Mapping Logs 904 record gesture-to-command mapping changes and usage patterns for system refinement. The Signer Logs 906 track signer-related activities, including customization and preferences, enabling adaptive performance and personalization. The Output Logs 909 document the generation and delivery of outputs, ensuring traceability and issue resolution. The Feedback Logs 910 store real-time user feedback, facilitating immediate system improvements and satisfaction tracking. The Recognition Logs 912 capture gesture recognition events, model inferences, and associated metadata for performance monitoring. The Device Logs 914 track device activity, configurations, and status changes for effective device management. The Streaming Logs 916 log real-time streaming sessions, including status updates and errors, for debugging and optimization. The Training Logs 919 record training session details, metrics, and anomalies to monitor AI model improvements. The Notification Logs 920 stores real-time delivery events and user interactions with system notifications. The Knowledge Logs 922 track retrieval and usage of knowledge base entries for auditability in retrieval-augmented generation tasks. The Collaboration Logs 924 capture multi-agent collaboration session activities and decisions to optimize workflows. The Gesture Logs 926 store gesture-related events, including creation, modification, and usage in various contexts. Lastly, the Anomaly Logs 929 document detected anomalies, resolution actions, and their outcomes, ensuring robust system monitoring and maintenance. Together, these logs provide a comprehensive, real-time view of system activity for efficient operation and troubleshooting.

Referring to FIG. 10, illustrated a block diagram of PoseTrack 1000, a lower and upper body motion tracker comprising a first electronic device integrated with a Universal Asynchronous Receiver-Transmitter (UART) device, in accordance with an embodiment of the present disclosure. PoseTrack uses compact IMU sensors strategically placed on the left and right sides of the body to track and interpret intricate motion patterns, enabling real-time gesture recognition for both upper and lower body movements. The core components of PoseTrack are detailed below. The Left IMU System consists of a series of IMU sensors 1008A, 1008B, . . . 1008N strategically placed on key points of the left side of the body, including fingers, wrist, elbow, shoulder, hips, and ankles, to collect gyroscopic, accelerometric, and positional data for precise gesture tracking. At its core is the Left IMU-UART Device 1010, which serves as the central processing and communication hub. It incorporates the First Microcontroller 1012 for primary data acquisition and pre-processing of raw sensor data and the Second Microcontroller 1014, which handles parallel data management, advanced computations, and synchronization of multi-sensor inputs. Communication between the sensors and microcontrollers is facilitated by Left IMU-UART Channels 1016A, 1016B, . . . 1016N, which provide independent, simultaneous communication to minimize latency. Additionally, the Left IMU-UART Ports 1018A, 1018B, . . . 1018N offer physical connections to the sensors, enabling modular scalability and easy integration of additional sensors with minimal complexity.

The Right IMU System includes the Right IMUs Device 1020, which serves as the main controller for managing IMU sensors on the right side of the body. Operating independently yet synchronized with the Left IMU System; it enables comprehensive full-body motion tracking. The Right IMUs 1022A, 1022B, . . . 1022N are a parallel set of sensors mirroring the placement of left-side IMUs, located on the fingers, wrist, elbow, shoulder, hips, and ankles. These sensors collect gyroscopic, accelerometric, and positional data for gesture recognition. The system also incorporates a Right IMUs UART Device, which, like its left-side counterpart, features multiple UART channels and ports for efficient data acquisition, processing, and synchronization, ensuring seamless integration and real-time performance.

The Communication and Data Flow in the system ensures seamless synchronization between the left and right IMU systems for accurate, real-time full-body gesture tracking. This is achieved by aligning data from both sides using timestamps and processing it in parallel microcontrollers. The processed data is then transferred to the central processing unit, such as a rotational stand or cloud-based server, via UART channels, enabling efficient and low-latency communication. The modular design, featuring multiple UART channels and ports, supports scalability by allowing the integration of additional sensors to enhance precision or extend tracking capabilities. The Pose Track Architecture offers several advantages: it ensures high precision through dedicated IMUs on both sides of the body and dual microcontrollers per UART device; reduces hardware complexity with its efficient use of UART channels and ports; supports scalability for adding advanced components or sensors; and delivers seamless real-time tracking through synchronized IMUs, making it ideal for real-time applications.

Referring to FIG. 11, illustrated the System Architecture Diagram 1100 of the Unified System for Gesture Recognition, Text Generation, and Multi-Modal Communication. The diagram shows the interactions between various components, subsystems, and communication layers within the system. User 1102 represents the individual interacting with the system through gestures or commands. Clients 1104 include a range of devices such as desktops 1106, laptops 1108, tablets 1110, and smartphones 1112. Gesture Genius 1114 is a lightweight, mobile device equipped with IMU and proximity sensors, allowing it to transfer gesture data to other components like the Rotational Stand. PoseTrack 1116 tracks and interprets upper and lower-body gestures, from finger movements to waist-level poses, in real-time.

Communication Protocols: Wi-Fi 1118 and Bluetooth 1120 enable secure and efficient data exchange between devices, including Gesture Genius, PoseTrack, and other subsystems. The Rotational Stand 1122 is a fixed device capable of capturing gestures, performing local processing, and monitoring movements for detailed analysis. The Edge Computing Device Controller (ECDC) 1124 bridges the user interface (UI) and hardware, ensuring seamless communication and command execution. The Internet or Cloud 1126 connects the edge devices to cloud-based resources for synchronization and remote processing. The Application Server 1128 manages the execution of application logic and coordinates requests from clients and subsystems, while the API Gateway 1130 serves as the interface for communication between client applications and system services.

Subsystems: Text-to-Gesture Overlay (TGO) 1132: Converts text into gesture overlays for visual representation. Video-to-Gesture Overlay (VGO) 1134: Maps gestures to video content, enabling dynamic and interactive overlays. Real-Time Text-to-Gesture Streaming (RTGS) 1136: Streams live text-to-gesture translations for accessibility and virtual communication. Gesture Cognition Engine (GCE) 1138: Processes multi-modal inputs, performs gesture recognition, anomaly detection, and gesture-to-command mapping. Gesture Recognition to Text (GRT) 1140: Translates gestures into text for applications such as sign language recognition. Multi-Agent Collaboration (MAC) 1142: Synchronizes gestures and actions across multiple devices or users. Gesture Video Generation (GVG) 1144: Generates gesture-based videos for training, education, or communication.

Databases within the system architecture include a NoSQL Database 1146 for storing unstructured data such as gesture session logs and configurations, a Vector Database 1148 for maintaining high-dimensional gesture embeddings used in similarity searches and recognition, and an SQL Database 1150 for storing structured data like gesture-to-command mappings and user profiles. The architecture demonstrates how user inputs are processed through edge devices, subsystems, and cloud infrastructure, enabling robust, adaptive, and touchless interaction in real-time across a wide range of devices and environments.

What is claimed is:

1. Multi-Modal Gesture Recognition System:
integrates a plurality of sensors comprising:
environmental sensors capturing ambient light, position, temperature, and sound to enhance the contextual interpretation of gestures;
dynamic input sensors capturing real-time data, including video, text, and audio, for seamless gesture recognition and interaction;
edge devices such as the Gesture Genius and Rotational Stand, enabling independent or collaborative gesture data processing with low latency;
contains:
Retrieval-Augmented Generation (RAG) that enhances contextual accuracy by retrieving and synthesizing gesture-related data from a knowledge base, offering variations and personalized gesture recommendations;
TGGMT (Multi-Modal Gesture Transformer+Generative Pretrained Transformer) that combines transformer-based gesture recognition and generative capabilities to predict gesture sequences, enhance fluency, and handle complex gesture patterns with high precision. It employs a validation loss-driven augmentation strategy that dynamically adjusts Data Augmentation Module (DAM) levels (0-N) based on validation loss stability. The model stops updating once it achieves predefined satisfactory performance (e.g., 99.99% accuracy threshold), ensuring optimal recognition and generation quality. Implements a flexible augmentation scaling mechanism where N is dynamically determined based on the experiment configuration file, ensuring adaptive learning across varied model training environments and datasets;
threshold-based model adaptation that implements distance threshold, accuracy threshold, and real-time threshold-based gradient updates to dynamically refine TGGMT model performance and adapt to user-specific gestures;
bidirectional loss computation that enhances gesture sequence prediction in TGGMT models by computing forward and reversed sequences independently, improving recognition accuracy for complex gestures and real-time adaptation;
polymorphic model design that supports dynamic switching between static gestures, dynamic gestures, fingerspelling, word-level recognition, and character-level tokenization, ensuring context-aware gesture processing across different applications;
Gesture Video Generation (GVG) service that facilitates the creation of gesture-based video overlays, synthesizing gestures based on text, pose data, or pre-existing video content;
cognitive models that predict user intent and adapt gestures dynamically based on user characteristics, preferences, and task context, ensuring personalized interaction;
anomaly that monitors for abnormal input patterns, unauthorized usage, or system attacks to ensure the system's security and reliability;
callback-based implements DAM (Data Augmentation Methods) level scaling (0 to 4) as a callback-driven augmentation strategy to improve TGGMT model performance, adjusting transformation intensity dynamically based on edit accuracy thresholds;
validation loss-based fine-tuning that replaces traditional early stopping techniques by incrementing DAM levels when validation loss does not improve over a defined number of iterations, ensuring a progressive refinement approach without premature convergence;
has software integration for:
gesture mapping service that converts maps input text into gesture video or actionable gesture instructions;
Gesture Video Generation that generates and customize videos to enhance accessibility;
rendering and overlay tools that overlay gestures onto real-time or pre-recorded videos, supporting gesture style customization based on user and regional preferences;
dynamic feedback mechanisms that provides users with real-time feedback on gesture accuracy and system performance using tools like Prometheus and Grafana;
adaptive learning pipelines that continuously evaluates gesture performance using threshold metrics and automatically updates model weights based on real-time gesture inputs;
extended that implements scale, translation, brightness, and image denoising enhancements to improve gesture dataset diversity, ensuring robustness in low-light, occluded, or challenging environments;
has hardware and communication:
that includes motorized, precision-controlled devices such as the Rotational Stand for touchless interactions in sensitive environments;
ensure secure, low-latency communication via MQTT or WebSocket protocols to facilitate seamless interaction between hardware and software components.

2. System Functional Enhancements
The system of claim 1 further integrates advanced platform capabilities to support diverse user requirements and operational contexts, including:
Real-Time Gesture Recognition and Conversion:
processes static and dynamic gestures through TGGMT (Hybrid+Generative Pretrained Transformer) models to ensure accuracy and contextual understanding;
that supports multi-language gesture recognition, including ASL and BSL, tailored to cultural and user-specific preferences;
implements distance and accuracy thresholds to dynamically refine gesture recognition through real-time model updates. These thresholds are used to adjust TGGMT weights for improved user-specific accuracy;
enhances TGGMT processing by computing both forward and reverse gesture sequences independently, reducing errors in dynamic gesture transitions;
that supports dynamic switching between static, dynamic, fingerspelling, word-level, and character-level tokenization, optimizing recognition for varied user interactions;
dynamically adjusts DAM levels (0-N) based on performance feedback to optimize gesture recognition model generalization and reduce overfitting risks;
uses edit accuracy thresholds and DAM (0-N) augmentation scaling to iteratively enhance gesture recognition accuracy, refining the model only when validation loss improvements plateau over a predefined patience period;
utilizes validation loss monitoring to selectively increase augmentation intensity, ensuring incremental performance improvements without abrupt model degradation;
Gesture-Based Content Generation:
leverages Gesture Video Generation (GVG) Models to create personalized video content incorporating gesture overlays for live or pre-recorded media;
that synthesizes gestures from textual, audio, or video inputs to enable gesture-based accessibility enhancements in education, healthcare, and corporate environments;
enhances gesture synthesis accuracy by incorporating scale, translation, brightness adjustments, and image denoising techniques to improve dataset diversity;
continuously evaluates gesture performance metrics and automatically updates gesture mapping models based on real-time user interactions;
Adaptive Gesture Interaction:
that utilizes Cognitive Models to predict user intent, dynamically adapt gestures, and ensure personalized interaction based on individual user characteristics, task context, or environmental conditions;
Security and Reliability:
deploys Anomaly Detection Models to monitor and detect unauthorized inputs, anomalies, or attacks on the gesture recognition and processing systems;
includes real-time safeguards, such as fallback mechanisms for ambiguous gestures, to maintain system performance and reliability;
Edge Device Integration and Management:
manages hardware devices like the Gesture Genius and Rotational Stand using Over-The-Air (OTA) updates and dynamic configuration adjustments;
implements secure communication protocols (e.g., MQTT, WebSocket) to ensure low-latency and encrypted data transfer between devices and the platform;
Feedback and Monitoring:
that employs Retrieval-Augmented Generation (RAG) features to provide detailed, context-rich feedback for improving gesture accuracy, user engagement, and system optimization;
integrates performance tracking tools (e.g., Prometheus, Grafana) to log system performance, latency, and error handling metrics;
implements real-time threshold monitoring to automatically adjust model parameters when recognition confidence falls below a predefined level;
uses RAG-enhanced analysis to detect gesture inconsistencies and provide real-time system adaptations.

3. Advanced System Integration and Scalability:
The system of claim 1 further incorporates enhanced integration, scalability, and optimization mechanisms to support dynamic operational environments and diverse user needs, including:
Scalable Multi-Agent Collaboration:
implements a Multi-Agent Collaborative (MAC) enabling multiple AI agents to work in coordination, sharing gesture-based commands, contextual data, and real-time updates for complex tasks and workflows;
ensures efficient resource allocation and seamless task execution across interconnected systems;
Federated Training and Learning Models:
that utilizes a Federated Training Approach to collaboratively train gesture recognition models across distributed edge devices (e.g., Gesture Genius and Rotational Stand) while maintaining data privacy and reducing latency;
adapts models in real-time to incorporate localized data without requiring centralized data storage;
incorporates distance threshold, accuracy threshold, and gradient-based updates to dynamically refine gesture recognition models on distributed edge devices without requiring centralized model retraining;
implements bidirectional loss training within federated learning pipelines, ensuring gesture models adapt in real-time to edge-specific variations and regional gesture preferences;
extends callback-based augmentation to distributed learning environments, ensuring model updates on edge devices progressively incorporate DAM-based augmentations for localized adaptation;
implements fine-tuned DAM progression across multi-agent edge training scenarios, enhancing system-wide scalability without requiring full retraining cycles;
implements DAM (0-N) scaling at the federated learning level, allowing localized model adaptation on edge devices while ensuring synchronized global updates via cloud training cycles;
Cross-System Compatibility and APIs:
supports robust integration with third-party applications, such as video editing software, live-streaming platforms, and presentation tools, via GraphQL and RESTful APIs;
provides modular microservices (e.g., Gesture Mapping, Rendering, Streaming Integration) to enhance the system's interoperability with diverse platforms and environments;
Gesture Customization and User Personalization:
enables real-time gesture customization through user-defined configurations stored in a scalable data model, incorporating preferences for gesture language, signer avatars, animation styles, and overlay settings;
offers a personalized experience by leveraging Cognitive Models to dynamically adapt gesture output based on user feedback, task requirements, and operational constraints;
introduces configurable gesture recognition pipelines that dynamically adapt to static gestures, dynamic gestures, fingerspelling, word-level recognition, and character tokenization based on user preference and real-time environmental factors;
uses threshold-based reinforcement learning to personalize gesture models dynamically by incorporating real-time user feedback and interaction patterns;
Performance Optimization and Monitoring:
employs a Feedback and Monitoring Service to track performance metrics, latency, and user interaction data, providing actionable insights for system refinement;
ensures low-latency gesture recognition and processing through hardware-accelerated rendering (e.g., Vulkan, DirectX) and optimized data transmission protocols (e.g., MQTT, WebSocket);
enhances gesture dataset diversity and robustness by incorporating scale, translation, brightness normalization, and image denoising techniques to improve gesture tracking under variable lighting and occlusion conditions;
implements real-time system monitoring, adjusting gesture recognition confidence thresholds dynamically based on performance feedback and user behavior analytics;
Edge and Cloud Scalability:
facilitates seamless scalability of the system by leveraging a hybrid architecture combining edge computing for real-time gesture processing and cloud infrastructure for storage, model updates, and large-scale analytics;
employs dynamic load balancing and elastic scaling mechanisms to handle high traffic or complex workflows without degrading system performance;
Compliance and Accessibility Standards:
ensures adherence to global accessibility standards, including ADA and WCAG, while maintaining compliance with data protection regulations such as GDPR and HIPAA;
includes accessibility features like gesture-to-text and text-to-gesture overlays to support users with disabilities in various domains, such as education, healthcare, and corporate environments.

4. Enhanced User Interaction, Security, and Operational Efficiency:
The system of claim 1 further provides advanced user interaction capabilities, robust security mechanisms, and operational efficiency enhancements, including:
Intuitive User Interaction:
integrates Real-Time Gesture Streaming (RTGS) to convert spoken or written text into real-time gesture overlays for accessible communication in live scenarios such as webinars and presentations;
supports dynamic, touchless gesture control for navigating user interfaces and executing commands, ensuring hygienic and hands-free operations in sensitive environments (e.g., healthcare facilities);
enhances accessibility through (GRT), allowing users to translate gestures into textual outputs for bidirectional communication;
Personalized Learning and Training:
incorporates an AI ASL Assistant Trainer that leverages Retrieval-Augmented Generation (RAG) to provide personalized sign language training modules, real-time gesture recognition feedback, and interactive exercises;
supports gamification features, such as achievements and leaderboards, to improve user engagement and learning outcomes;
Robust Security and Anomaly Detection:
utilizes Anomaly Detection Models to monitor and identify abnormal input patterns, unauthorized access attempts, or system anomalies, ensuring the safety and integrity of the platform;
employs end-to-end encryption, secure authentication protocols (e.g., OAuth 2.0), and role-based access control (RBAC) to protect user data and platform functionality;
Efficient Edge Device Management:
includes Device Registration and Management Services to handle the onboarding, monitoring, and configuration of edge devices (e.g., Gesture Genius and Rotational Stand);
supports Over-The-Air (OTA) firmware updates, real-time configuration adjustments, and secure connectivity using low-latency communication protocols like MQTT and WebSocket;
Data and Performance Optimization:
implements Cognitive Models to predict and adapt to user behavior, optimizing system responses and interactions in real time;
tracks system performance through a and Monitoring Service, logging metrics like gesture recognition accuracy, latency, and user interaction data to enable continuous optimization;
Comprehensive Data Management:
employs a scalable data model to efficiently store and retrieve gesture embeddings, user preferences, and configuration profiles for personalized system interactions;
supports metadata tagging (e.g., timestamp, device ID) for embedding retrieval, enhancing the contextual accuracy of gesture processing;
Multi-Environment Adaptability:
adapts seamlessly to diverse operational environments, including remote educational settings, public service applications, and high security workplaces;
provides cross-platform support for web-based dashboards, mobile applications, and streaming services, ensuring universal accessibility;
Compliance and Ethical Standards:
ensures adherence to ethical AI practices and compliance with industry standards, including GDPR, HIPAA, ADA, and WCAG;
incorporates transparent data usage policies and customizable privacy settings to empower users and protect sensitive information.

5. Edge-Based Gesture Recognition and Resource Sharing
The system of claim 1 further supports edge-based gesture recognition and resource-sharing mechanisms, including:
Edge Computing for Gesture Recognition:
implements real-time gesture recognition on edge devices, such as Gesture Genius and Rotational Stand, to reduce latency and ensure fast, localized processing;
supports dynamic gesture detection and classification, leveraging lightweight AI/ML models optimized for edge deployment (e.g., TF-Lite models);
implements distance and accuracy thresholds to dynamically refine gesture recognition performance on edge devices, ensuring adaptive model updates without requiring constant cloud communication;
integrates bidirectional loss training to improve gesture prediction accuracy on edge devices, allowing gesture models to be optimized using both forward and reverse sequences;
supports real-time switching between static gestures, dynamic gestures, fingerspelling, word-level, and character-level tokenization, enabling versatile, low-latency gesture recognition directly on the device;
Collaborative Resource Sharing:
enables resource sharing across edge devices to balance processing loads dynamically, ensuring consistent performance during high-demand scenarios;
facilitates Multi-Agent Collaboration (MAC) by enabling edge devices to share gesture commands, contextual updates, and processing outputs for coordinated
Localized Data Processing:
processes gesture inputs locally on edge devices to minimize data transmission requirements, preserving bandwidth and reducing reliance on cloud infrastructure;
supports localized learning updates for AI models, integrating federated training to improve system performance without centralized data aggregation;
enhances gesture dataset diversity on edge devices by applying scale, translation, brightness normalization, and image denoising techniques, ensuring consistent gesture recognition performance under varying environmental conditions;
dynamically increases or reduces DAM levels on edge devices based on local validation loss and gesture classification accuracy, ensuring optimal model adaptation without cloud dependency;
adjusts augmentation intensity dynamically on edge devices based on real-time gesture recognition performance, ensuring optimal accuracy while preserving computational efficiency;
uses edit accuracy thresholds to trigger fine-tuned augmentation levels, ensuring continuous optimization of real-time gesture recognition;
Synchronization with Central Systems:
maintains synchronization between edge devices and cloud servers to ensure consistency in gesture recognition, data sharing, and operational updates;
uses secure and low-latency communication protocols (e.g., MQTT, WebSocket) to link edge and cloud systems efficiently.

6. Gesture Recognition Device with Privacy-Preserving Features
The system of claim 1 further integrates privacy-preserving features within gesture recognition devices, including:
Anonymized Gesture Processing:
incorporates Anomaly Detection Models to ensure that gestures are processed without revealing sensitive user data, maintaining anonymity in all interactions;
leverages privacy-preserving algorithms, such as homomorphic encryption and differential privacy, to secure data during transmission and processing;
On-Device Data Handling:
stores and processes gesture-related data locally on devices, minimizing the need to transmit raw data to external servers and reducing exposure to potential breaches;
implements secure access controls, including encryption and role-based access, to restrict unauthorized usage or tampering;
Real-Time Privacy Monitoring:
monitors system activities in real-time to detect and mitigate unauthorized access, misuse of gesture data, or attempts to bypass security protocols;
provides users with detailed privacy dashboards for managing preferences, including gesture history, data sharing settings, and consent management;
Secure Hardware Integration:
deploys tamper-resistant hardware components in devices such as Gesture Genius and Rotational Stand to prevent physical attacks or unauthorized modifications.

7. Cloud-Assisted Heavy Processing for Gesture-Based Applications
The system of claim 1 utilizes cloud-assisted heavy processing to enhance the performance of gesture-based applications, including:
Cloud-Based Model Optimization:
performs computationally intensive tasks, such as training and refining AI models for gesture recognition and generation, on cloud infrastructure using robust frameworks (e.g., TensorFlow, PyTorch);
supports periodic updates to edge-deployed models via Over-The-Air (OTA) mechanisms to ensure optimal accuracy and performance;
implements distance threshold, accuracy threshold, and performance-driven gradient updates to dynamically refine gesture recognition models based on aggregated cloud data;
enhances gesture sequence learning by utilizing bidirectional loss computation, ensuring improved accuracy in cloud-trained gesture models;
implements callback-driven DAM scaling for server-side model optimization, dynamically applying augmentation strategies (DAM 1-4) to prevent overfitting while enhancing generalization for large-scale deployments;
replaces static augmentation presets with dynamic augmentation levels, progressively refining gesture models based on real-time performance analytics;
implements adaptive augmentation scaling for cloud-based gesture dataset training, progressively adjusting N based on dataset variability and model performance analytics;
Scalable Cloud Architecture:
leverages scalable cloud resources to handle high-volume data processing for applications like Three-stage Gesture Generative Multi-Modal Transformer (TGGMT), Gesture Video Generation (GVG) and Retrieval-Augmented Generation (RAG);
dynamically allocates resources to manage peaks in demand, ensuring uninterrupted performance for gesture-based workflows;
polymorphic Gesture Processing in Cloud Models: Enables cloud-based models to support multi-modal gesture classification, dynamically switching between static gestures, dynamic gestures, fingerspelling, word-level, and character-level tokenization for optimized context-aware processing;
cloud-Augmented Data Preprocessing: Enhances gesture dataset quality using scale, translation, brightness normalization, and image denoising, improving gesture model robustness for large-scale applications;
Advanced Data Analytics:
processes large-scale gesture datasets in the cloud for analytics, enabling insights into user behavior, system performance, and model improvements;
employs cloud-hosted visualization tools to provide actionable insights and interactive dashboards for stakeholders;
Seamless Integration with Edge Devices:
maintains a hybrid architecture that enables edge devices to offload heavy computational tasks to the cloud while ensuring real-time operations at the edge;
synchronizes gesture recognition results and updates between edge and cloud systems to ensure consistency and reliability;
adaptive Learning Pipelines for Edge-Cloud Synchronization: Employs threshold-based performance evaluation to update edge models dynamically without unnecessary cloud dependency, optimizing gesture processing latency;
uses cloud-based analytics to assess gesture recognition accuracy and automatically adjust model hyperparameters for edge deployment;
Secure Cloud Processing:
protects data integrity and privacy during cloud processing by employing secure storage, encryption, and GDPR/HIPAA-compliant practices;
implement robust access control mechanisms to manage permissions for cloud-hosted applications and data.

8. Integrated Motion Tracking Device Utilizing Multi-Channel UART for Real-Time Gesture Recognition
The system of claim 1, wherein the first electronic device and second electronic device each comprise a Universal Asynchronous Receiver-Transmitter (UART) device configured to enable simultaneous communication with multiple IMU sensors via a plurality of UART channels, wherein:
the first UART device includes two micro-controllers coupled to process data in parallel, reducing latency during real-time motion tracking;
plurality of UART channels enables independent communication between the first and second electronic devices and their respective IMU sensors on the left and right sides of the body;
UART devices further include UART ports to couple additional peripheral devices or external modules for extended tracking capabilities;
UART-Based Motion Tracking and Processing:
implements distance and accuracy thresholds for motion tracking calibration, ensuring real-time adaptive tuning of IMU-based gesture recognition models;
integrates bidirectional data flow computation to optimize motion tracking accuracy, reducing latency in detecting real-time upper and lower body gestures;
supports dynamic switching between static pose tracking, dynamic motion tracking, fingerspelling, word-based gestures, and character-level tokenization, enabling context-aware adaptation of motion recognition algorithms;
UART Data Synchronization & Peripheral Expansion:
aggregates multi-channel IMU sensor data to improve gesture accuracy across multiple body landmarks (fingers, wrists, elbows, shoulders, hips, knees, and ankles);
applies scale normalization, translation correction, and denoising algorithms to enhance motion signal clarity, ensuring robust gesture classification even under variable movement conditions.
